(19) United States
(12) Patent Application Publication
(10) Pub. No.: US 2026/0095031 A1
(43) Pub. Date: Apr. 2, 2026

(54) COMPARTMENTALIZED POWER DISTRIBUTION EQUIPMENT

(71) Applicant: Schneider Electric USA, Inc., Boston, MA (US)

(72) Inventors: Carlos Alberto Gutiérrez, General Escobedo (MX); Victor Daniel Espinosa, General Escobedo (MX); Juan Daniel Martin Reynoso, Monterrey (MX); Montserrat González de León, General Escobedo (MX); Mariana Guevara, Monterrey (MX)

(21) Appl. No.: 19/035,430

(22) Filed: Jan. 23, 2025

Related U.S. Application Data
(60) Provisional application No. 63/702,305, filed on Oct. 2, 2024.

(51) Int. Cl. H02B 1/26; H02B 1/20; H02B 3/00

(52) U.S. Cl. CPC H02B 1/26; H02B 1/20; H02B 3/00

(57) ABSTRACT

The embodiments describe arrangements of internal components for power distribution equipment which optimize equipment performance. A compartment partition is disclosed, the partition configured to be inserted to power distribution equipment and maintained therein for sub-dividing the compartment. An inverted load center is disclosed which, in conjunction with the compartment partition, facilitates the separation of disconnects without the need to expand the power distribution equipment within which such compartments, disconnects, and load centers are located. The embodiments also describe a method which, among other things, relates to the installation of the compartment partition.

### CROSS-REFERENCE TO RELATED APPLICATION

This application claims priority to U.S. Provisional Patent Application No. 63/702,305, filed Oct. 2, 2024, the entire disclosure of which is incorporated herein by reference.

### FIELD

The present disclosure relates generally to power distribution equipment and, more particularly, to power distribution equipment configured to optimize space and user experience.

### BACKGROUND

Service panels including circuit breakers or breaker switches are frequently used in both commercial and residential structures as a way to control the distribution of electrical power. They also cut power in the event of a power surge. For example, branch circuit breakers may control power delivery to a specific floor, room, or appliance. The service panel also includes primary breaker switches for controlling the flow of power through the circuit breaker and the structure altogether. These service panels are typically located inside the structure. In another application, primary breaker switches are located outside the structure where local codes require the ability to disconnect power to the structure from outside the structure. These primary circuit breaker switches may be part of a device called a meter main, which in some cases, includes a combination of a disconnect panel with the primary breaker switches and a meter socket for an electrical meter.

Regulations may require separate compartments when more than a single disconnect (i.e., an electrical disconnect) is in place. Residential services above 200 amperes (A) are typically load split. With walls intended to compartmentalize, installation practices can become more complex. An installer of power distribution equipment may face limitations when installing a compartment using some (e.g., legacy) approaches.

Section 230.71(B) of the National Electrical Code (NEC) discusses requirements with respect to using two to six service disconnects. Specifically, section 230.71(B) of the NEC requires multiple service disconnects to be separated in certain circumstances wherein service disconnect separation was not previously required.

### SUMMARY

Aspects of the present disclosure provide a new arrangement of a power distribution panel to improve (e.g., optimize) the customer experience using a reduced footprint to comply with typical construction practices. Metering equipment according to one or more embodiments of the present disclosure can help the installer to have an easier installation by relocating the load center from the bottom to the top in comparison with those (e.g., legacy) approaches. For example, the installer may have a shorter current path of wires to install and have fewer/shorter cables to move from one compartment to another compartment in the metering equipment. Also, the compartment can protect the installer from inadvertently touching parts if/when the installer subsequently installs an accessory, a breaker, or a surge protective device (SPD) on the load center.

In one aspect, power distribution equipment is disclosed having a housing with at least four side walls and a rear wall. The housing defines an equipment interior, wherein a primary barrier extends between opposite side walls thereof. The primary barrier defines a first compartment and a second compartment within the equipment interior. The equipment includes a first electrical disconnect and a second electrical disconnect, each of the disconnects being located in the second compartment, as well as a compartment partition maintained in the second compartment and extending thereacross. The compartment partition defines a first sub-compartment and a second sub-compartment. The first electrical disconnect is located in the first sub-compartment and the second electrical disconnect is located in the second sub-compartment.

In another aspect, a compartment partition comprising a metal plate configured to divide a compartment interior of power distribution equipment into a first sub-compartment and a second sub-compartment is disclosed. The compartment is defined by an upper compartment wall, a lower compartment wall, and two side compartment walls, and the metal plate comprises a partition width and a partition depth and defines an opening therein.

In yet another aspect, a method of separating a first electrical disconnect switch and a second electrical disconnect switch in power distribution equipment is disclosed. The power distribution equipment includes a housing having at least four side walls and a rear wall, the side walls defining an equipment interior, the housing further including a barrier. The barrier extends between opposite side walls of the housing and defines a first compartment and a second compartment within the equipment interior. The method comprises installing a compartment partition within the second compartment such that the second compartment defines a first sub-compartment and a second sub-compartment, installing the first electrical disconnect switch in the first sub-compartment, and installing the second electrical disconnect switch in the second sub-compartment. The second compartment has a compartment depth, the compartment partition has a partition depth, the side walls of the housing define a housing depth, and the partition depth is at least 80% of the housing depth.

### BRIEF DESCRIPTION OF THE DRAWINGS

FIG. 1 is a front elevation of prior art power distribution equipment.

FIG. 2A is a front elevation of prior art power distribution equipment.

FIG. 2B is a front elevation of prior art power distribution equipment.

FIG. 3 is a front elevation of power distribution equipment according to an embodiment.

FIG. 4 is a perspective view of the power distribution equipment of FIG. 3, and includes greater detail.

FIG. 5 is similar to FIG. 3, but includes greater detail.

FIG. 6A is a perspective of a compartment partition according to an embodiment.

FIG. 6B is a top view of the compartment partition of FIG. 6A.

FIG. 7 is a flow chart of a method according to an embodiment.

### DETAILED DESCRIPTION

Aspects of the present disclosure relate generally to power distribution equipment. The illustrated embodiments show the power distribution equipment as being a meter main. As such, the term “meter main” may be used to describe certain embodiments (e.g., the illustrated embodiments) as opposed to the term “power distribution equipment”. This does not indicate that the embodiments disclosed herein are limited only to meter mains.

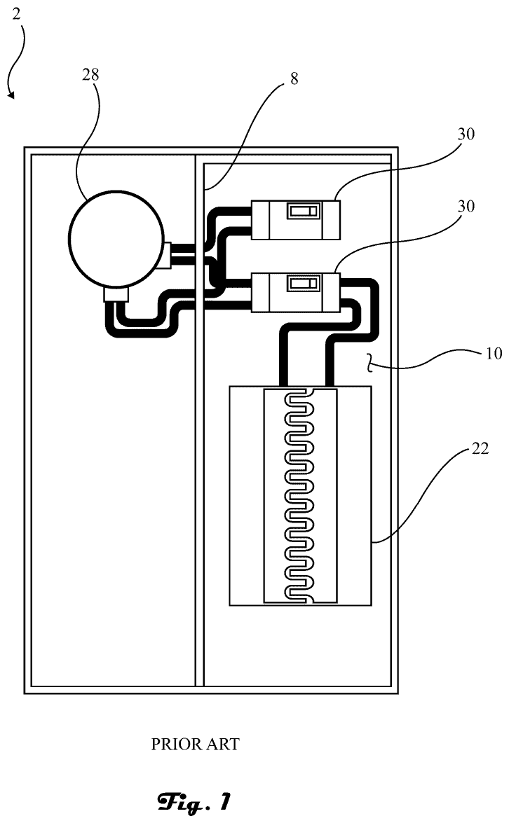

This disclosure includes references to “pre-update” and “post-update” power distribution equipment. This refers to power distribution equipment designed and/or manufactured before or after the update to Section 230.71(B) of the NEC which, under certain circumstances, requires the separation of two or more main service disconnects into separate compartments. For example, FIG. 1 shows a “pre-update” meter main, as the meter main of FIG. 1 was designed before the inclusion of the aforementioned NEC update and, thus, does not include a partition in-between its two disconnects. The update in the NEC as described above may also be referred to generically as “the update to the NEC” or “the NEC update” or “the update”.

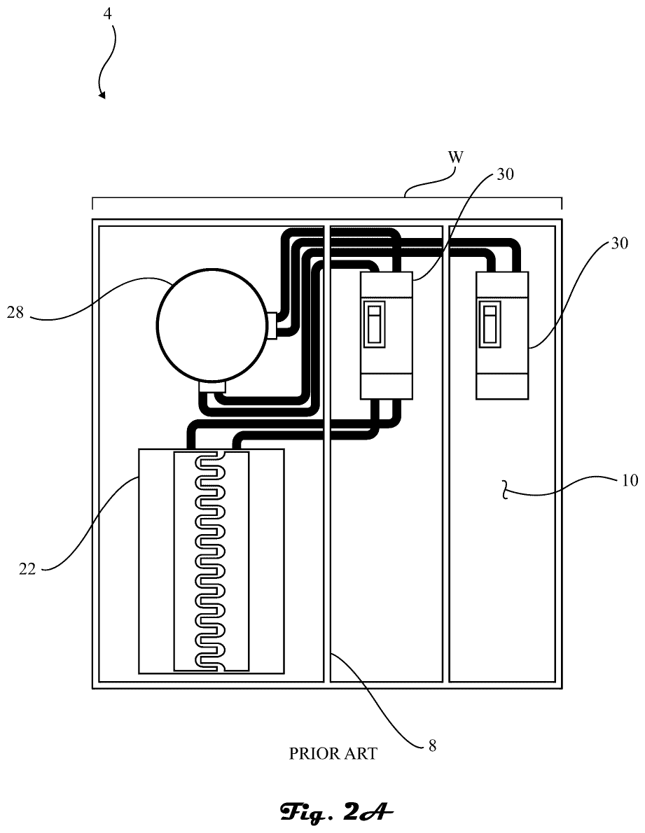

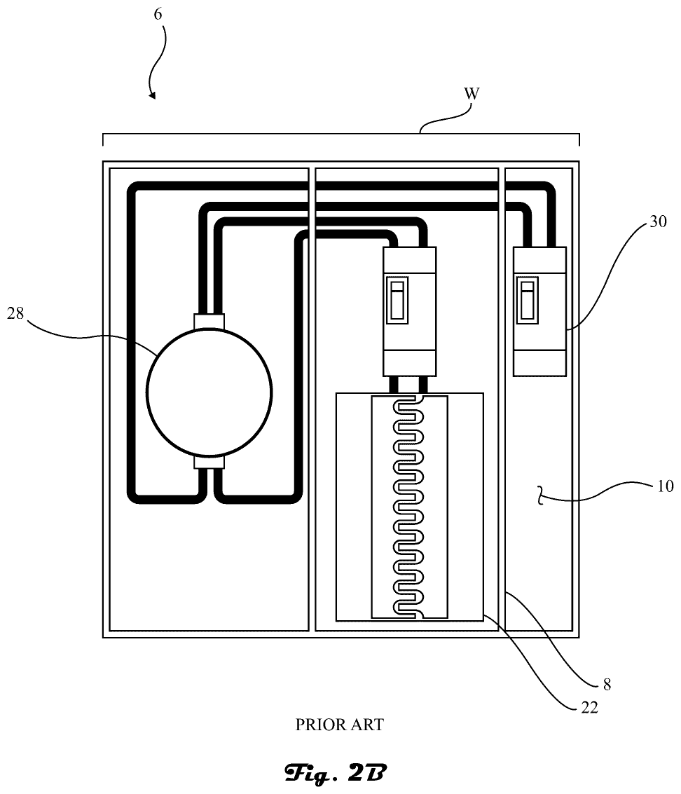

Though redundant, most references to prior art power distribution equipment (e.g., the legacy systems included in FIGS. 1, 2A, and 2B) will include the term “prior art” so as not to confuse embodiments of the present invention with existing systems. Additionally, prior art power distribution equipment and all components thereof will generally be identified by reference numbers less than 100, while embodiments of the present invention and all components thereof will generally be identified by reference numbers equal to or greater than 100. Prior art power distribution equipment is included to illustrate the difference between not only pre-update power distribution equipment and post-update power distribution equipment, but between embodiments of the present invention (which address the NEC update adequately) and other post-update systems (which do not, in the Applicant's view, address the NEC update adequately).

FIG. 1 shows a front elevation of pre-update prior art meter main 2. The prior art meter main 2 of FIG. 1 does not meet the most recent specifications of the NEC as enumerated under section 230.71(B) thereof, as it contains two disconnecting means 30 within the same compartment 10 (i.e., there are not separate enclosures with a main service disconnect in each enclosure).

FIG. 2A shows a front elevation of a post-update prior art meter main 4. As such, it was designed to meet the limitations for equipment with multiple disconnects 30 by holding them in separate compartments. As shown in FIG. 2A, this prior art meter main 4 includes three vertically extending compartments 10 for housing various components thereof (e.g., a load center 22), two of which are utilized as separate enclosures for separating a main service disconnect 30 in each. The individual compartments 10 are arranged side-by-side along a width W. In FIG. 2A, the load center 22 is maintained in the leftmost compartment along with metering equipment 28 for recording power consumption.

Referring now to FIG. 2B, a post-update prior art meter main 6 is shown having similar design characteristics to the prior art meter main of FIG. 2A: vertical walls 8 defining three individual compartments 10 spaced apart along the width W of the prior art meter main. Unlike the prior art meter main 4 of FIG. 2A, the prior art meter main 6 of FIG. 2B includes the load center 22 in the centermost compartment 10, leaving the metering equipment 28 physically isolated in the leftmost compartment 10.

The prior art meter mains 4, 6 of FIGS. 2A & 2B are intended to illustrate inadequacies in the present design of meter mains which include separate enclosures for main service disconnects, particularly those with two main service disconnects. As illustrated, vertical walls 8 are used to define separate vertical enclosures. This configuration of compartments satisfies the requirements of the updated NEC, but does so at significant detriment to the compactness of the meter main.

Increases in the footprint (i.e., dimensions) of meter mains incur significant cost when deployed at scale. The prior art meter mains of FIGS. 2A & 2B, which represent the majority of 400-amp meter mains currently being produced in North America, demonstrate a notable increase in width when compared to their pre-update counterparts (e.g., the prior art meter main 2 of FIG. 1). This increase in width W must be accounted for when replacing old (e.g., pre-update) meter mains with new meter mains (e.g., post-update). This is a burden on electricians who must perform such installations, as the area surrounding the install site may need to be modified in order to accommodate the increase in width. Additionally, because newly designed meter mains utilize a number of standard electronic components, the smaller footprint of pre-update meter mains cannot be achieved by merely narrowing each enclosure.

Additionally, manufacturers of meter mains may use a single housing for many different meter main models, even if such models utilize different equipment and are intended for different uses; however, the inclusion of a third vertically extending compartment precludes the use of existing housings from being used in new, post-NEC-update meter mains without significant modification, as the dimensions of the sheet metal from which the housing is formed must be increased. As such, there is significant benefit in the ability to create a meter main which satisfies the limitations of the post-update NEC, but which does so without modifying the dimensions of the meter main.

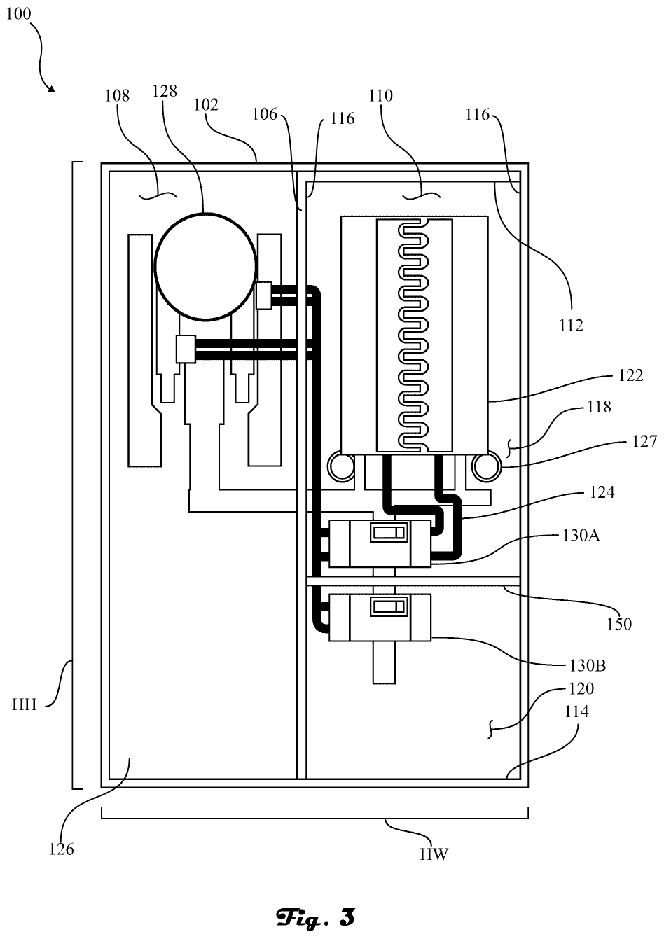

Referring now to the illustrated embodiment of FIG. 3, an embodiment of the present invention is disclosed in the form of a simplified schematic. FIG. 3 shows a meter main 100 which satisfies the updated NEC, but which does so at no expense to compactness (i.e., the dimensions of this meter main are identical to the dimensions of the pre-update meter main from which it is derived, and less than other meter mains presently on the market). The meter main 100 of FIG. 3 bears resemblance to existing (e.g., legacy) meter mains with respect to some aspects; a housing 102 defines an equipment interior in which electrical cables 124, metering equipment 128, and two main service electrical disconnects 130 are located. Unlike the post-update meter mains of the previous figures, however, the housing 102 has a notably smaller overall width HW, which is achieved by strategic arrangement of components, including a horizontally extending compartment partition 150 and an inverted load center 122.

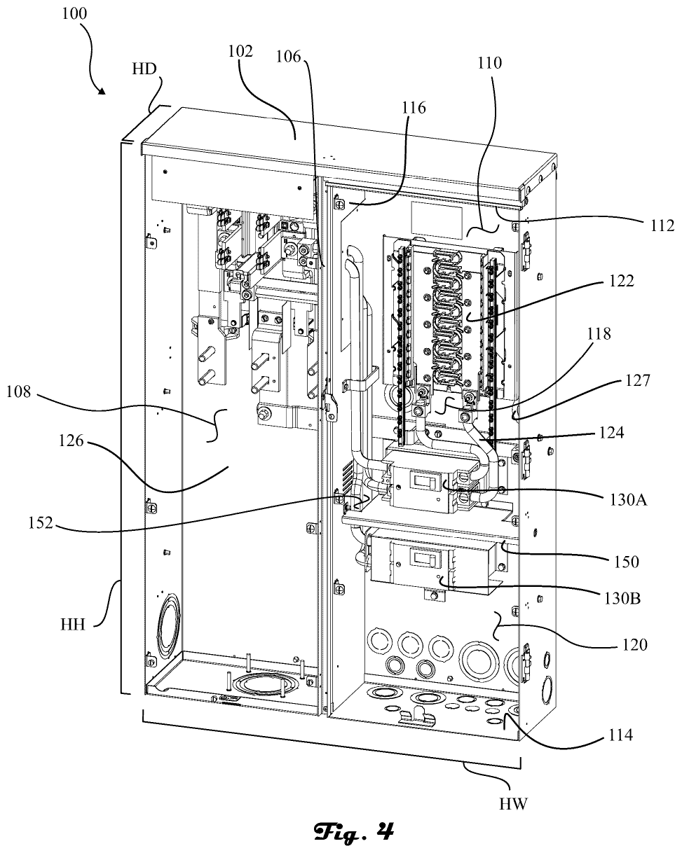

Referring now to the illustrated embodiments at FIGS. 4 & 5, the illustrated meter main 100 generally comprises housing 102 having a housing width HW (e.g., a distance between horizontally opposing side walls), a housing depth HD, and a housing height HH (e.g., a distance between vertically opposing side walls). The housing 102, along with a rear wall 126 and doors (not shown) define an equipment interior. The housing 102 maintains and protects a number of internal components, including a primary barrier 106 which divides the equipment interior into a first compartment 108 and a second compartment 110 such that components therein are physically isolated from one another. The second compartment 110 is further subdivided into a first sub-compartment 118 and a second sub-compartment 120 by the compartment partition 150 which is maintained therein and extends thereacross. The first sub-compartment 118 includes the load center 122 in an inverted configuration (the details and significance of the inverted configuration will be discussed later in the present disclosure), as well as a first disconnect 130A (e.g., a main electrical disconnect for the meter main 100). The second sub-compartment 120 includes a second disconnect 130B (e.g., a main electrical disconnect for the meter main 100). The load center 122 and each of the first and second disconnects 130A, 130B are connected via a plurality of electrical cables 124.

In an example embodiment, the housing width HW is no more than 28.25″, the housing depth HD is no more than 7.87″, and the housing height HH is no more than 43″. In the illustrated embodiment, the housing 102 has a substantially rectangular geometry which generally corresponds to the aforementioned dimensions, and is defined by at least four side walls (e.g., top, bottom, left, right) that define the equipment interior. The primary barrier 106 extends vertically through the equipment interior, forming a connection between opposite side walls of the housing (e.g., side walls across from one another, such as top/bottom side walls, left/right side walls, etc.). Specifically, the primary barrier 106 connects the bottom side wall and the top side wall of the housing 102. In the illustrated embodiment, the primary barrier 106 divides the equipment interior into first and second compartments 108, 110 of approximately equal size; however, in alternative embodiments, the primary barrier 106 may be located elsewhere within the equipment interior so long as all necessary components of the meter main 100 can fit within the housing 102 without an extension of any of the enclosure dimensions (i.e., housing height HH, housing depth HD, and housing width HW). Each of the first and second compartments 108, 110, like the primary barrier 106, extend vertically along the height of the housing HH. Additionally, each of the first and second compartments 108, 110 have a number of walls defined by the primary barrier 106, the rear wall 126, and the housing 102. These walls may be referred to as upper compartment walls, lower compartment walls, side compartment walls, and rear compartment walls. For example, a left side compartment wall 116 of the second compartment 110 is defined by the primary partition 106, and a bottom side wall 114 of the second compartment 110 is defined by one of the housing side walls. For each compartment 108, 110, the distance between the side (e.g., left and right) compartment walls defines a compartment width, the distance between the upper compartment wall and the lower compartment wall defines a compartment height, and the distance between the rear compartment wall and a front edge of the primary barrier defines a compartment depth.

Referring again to the illustrated embodiments FIGS. 4 & 5, the second compartment 110 is divided by compartment partition 150 maintained therein and extending thereacross. In the illustrated embodiment, the compartment partition 150 extends horizontally along the housing width HW and perpendicular to the primary barrier 106, resulting a substantially rectangular geometry for both the first and second sub-compartments 118, 120. The compartment partition 150 divides the second compartment 110 into first and second sub-compartments 118, 120 of approximately equal size; however, in alternative embodiments, the compartment partition 150 may be located elsewhere in the second compartment 120.

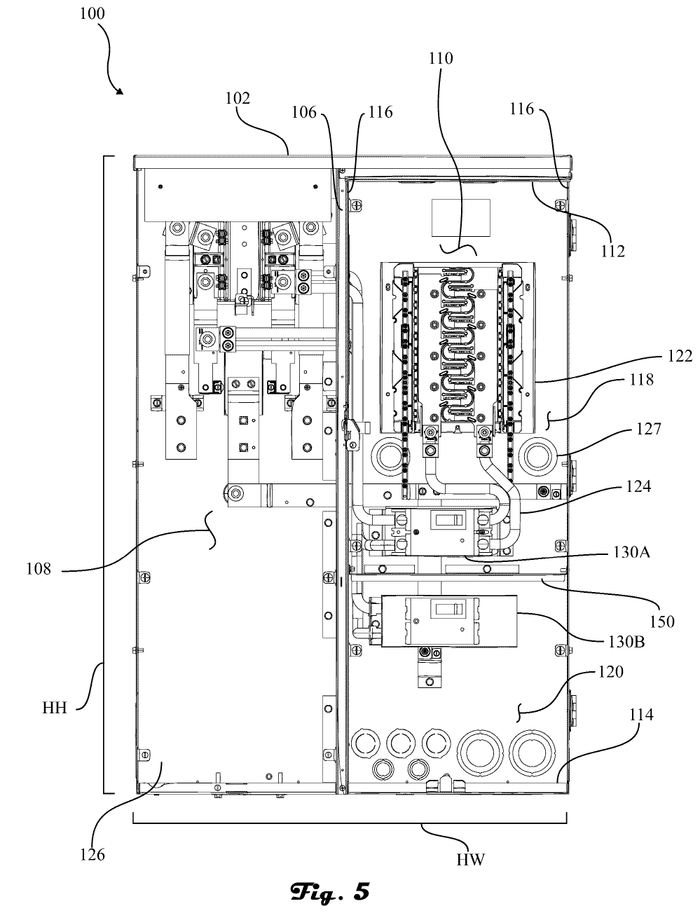

Referring to the illustrated embodiments at FIGS. 4-6B, the compartment partition 150 will now be described in greater detail.

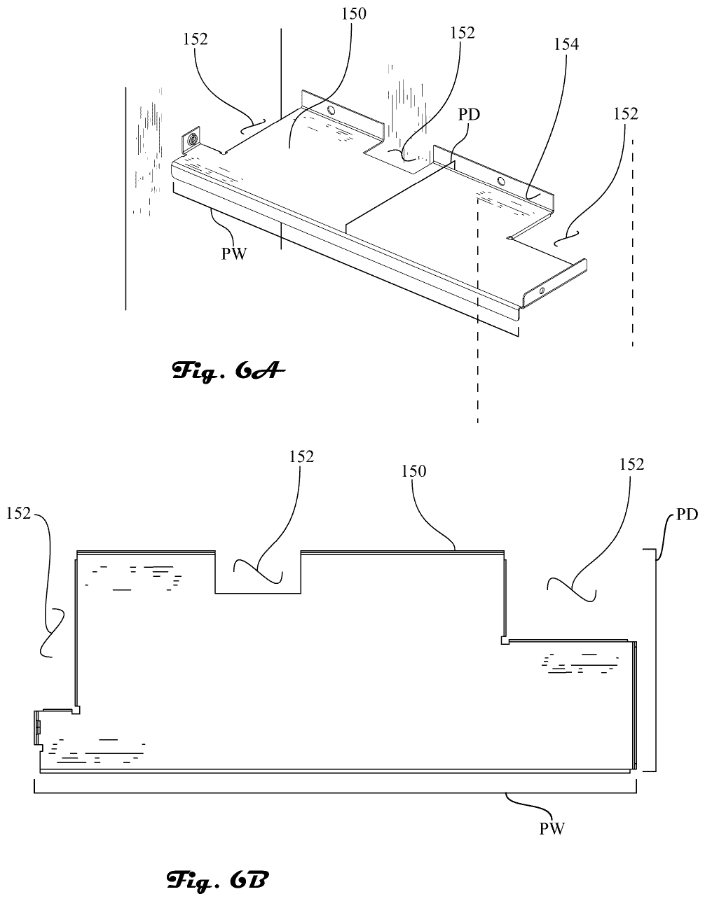

The compartment partition 150 has a partition depth PD and a partition width PW which, in the illustrated embodiment, extend in the same direction as the housing depth HD and housing width HW of the housing 102, respectively. The partition depth PD is different than the compartment depth, and may also be different than the housing depth HD (e.g., the partition depth PD is 90% of the housing depth, the partition depth PD is 80% of the housing depth, the partition depth PD is 70% of the housing depth, the partition depth PD is 5 inches, etc.). In the illustrated embodiments at FIG. 4 and FIG. 6A, for example, the partition depth PD is shown as being less than both the housing depth and the compartment depth. When a front surface (e.g., a door, not shown) is attached to the housing 102 and in the closed configuration, the difference between these two depths results in at least one horizontally extending opening (e.g., along an axis parallel to the housing width HW). When the compartment partition 102 is located rearward in the second compartment 110 such that the rear partition edge is in contact with the rear wall 126, the horizontally extending opening is defined toward a front of the equipment interior. In this configuration, the compartment partition 150 extends only part of the way from the rear wall 126. In alternative embodiments, the degree of this extension varies, and may be changed in order to adapt to future updates to the NEC, or for other purposes (e.g., the compartment partition 150 extends 90% of the way from the rear wall 126 to a front surface, the compartment partition 150 extends 80% of the way from the rear wall 126 to a front surface, the compartment partition 150 extends 70% of the way from the rear wall 126 to a front surface, the compartment partition extends 5 inches from the rear wall 126 to a front surface, etc.).

In the illustrated embodiments, the compartment partition includes a plurality of tabs, generally indicated at reference number 154. These tabs define drill holes used to secure the compartment partition 150 within the second compartment 110. In the illustrated embodiment, the compartment partition 150 is formed from a single piece of sheet metal, wherein the tabs are folded (e.g., bent) regions of the compartment partition 150. Thus, the compartment partition 150 generally comprises a metal plate configured to physically isolate the first electrical disconnect 130A in the first sub-compartment 118 from the second electrical disconnect 130B in the second sub-compartment 120. This single-sheet design simplifies both the manufacture and installation of the compartment partition 150.

The compartment partition 150 defines at least one partition opening 152. In the illustrated embodiment, there are a plurality of partition openings 152 of varying sizes. While the partition openings 152 of the illustrated embodiment are generally rectangular in shape, they may be a different shape in alternative embodiments. The partition openings 152 permit the electrical cables 124 to pass through the compartment partition 150, enabling electrical components (e.g., main service disconnects, load centers, etc.) to be electrically connected to one another even if they are located in distinct compartments 108, 110 or sub-compartments 118, 120. This can be seen, for example, in FIG. 4.

The partition openings 152 further serve as a conduit for the free flow of air from the first sub-compartment 118 to the second sub-compartment 120 and vice versa, creating a fluid connection therebetween. Air flow is an important consideration in the design of electrical equipment, especially high-amperage equipment such as those of the illustrated embodiments, as proper air circulation prevents any one component from overheating. For example, an excess of heat accumulated at the second disconnect 130B in the second sub-compartment 120 may be adequately reduced as the hot air rises upward into the first sub-compartment 118 via one of the partition openings 152. The hot air may then continue to circulate into the first compartment 108 via a compartment opening, or to ambient via a conduit knockout 127 which may be located in any of the compartments 108, 110 or sub-compartments 118, 120 (e.g., in a side wall of the housing 102 at the first sub-compartment 118). As such, the partition openings 152 increase both safety (e.g., safety for an operator working on or at the meter main 100) and performance (e.g., the lifespan of components within the meter main, and therefore the meter main itself).

Referring to the embodiments at FIGS. 4 & 5, the load center 122 and electrical disconnects 130 will be described in greater detail.

The arrangement of internal components for the meter main 100 allows the integration of the compartment partition 150 without the need to increase the dimensions of the meter main 100. In particular, the inverted configuration of the load center 122 allows for the first disconnect 130A to be maintained in the first sub-compartment 118 and the second disconnect 130B in the second sub-compartment 120. The inverted configuration of the load center 122 also reduces the amount electrical cabling 124 needed to route each of first and second main electrical disconnects 130A, 130B to and from both the load center 122 itself and the metering equipment 128 in the first compartment 108 (see FIG. 3). The meaning of the term “inverted” in this context refers to the flipping of cable terminals for the load center 122 to a position at the bottom of the load center 122 as opposed to at the top. Referring briefly to FIG. 1, FIGS. 2A & 2B, standard (e.g., prior art) load centers 22 have terminals at the top of the load center 22. There are number of reasons for this, primarily because meter mains typically route electrical cabling through the top (e.g., through a knockout on a top wall of the housing). Additionally, perhaps merely for consistency, load centers with top mounted terminals have become the standard in field. As such, it is likely the case that the standard configuration of load centers has been taken for granted, and therefore prevented those in the field from seeking solutions to problems which may require a load center inversion. Referring again to FIGS. 4 & 5, one can clearly identify the advantage of the inverted load center 122 with respect to the allocation of space within the first sub-compartment 118.

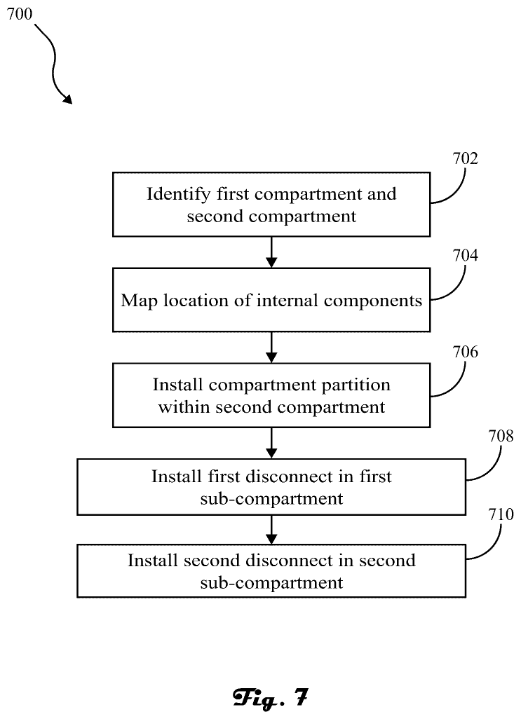

Referring now to FIG. 7, a method according to an embodiment of the present invention for separating two electrical disconnect switches within power distribution equipment is disclosed, and is generally indicated at reference number 700. The method 700 allows existing housings (i.e., housings designed and manufactured for pre-update meter mains) to be retrofitted with a compartment partition such that they may be used to produce post-update, NEC compliant meter mains. As discussed in part above, the ability to use existing materials/designs in the production of new power distribution equipment offers significant advantages to manufacturers. These benefits are compounded by a failure of the Applicant's competitors to do the same.

At operation 702, the first and second compartments are identified. Referring briefly to the embodiments shown in FIGS. 3-5, the first compartment 108 is the compartment configured to have metering equipment (e.g., meter equipment 128) located therein. This may be determined by, for example, identifying a door (not shown) having a cutout for allowing an operator to view the metering equipment without having to open the door. There may also be other markers, indicators, or structures within the first and/or second compartments which facilitate their identification, such as knockouts of specific size, shape, or position. If no substantial difference is present, the first and second compartments may be chosen arbitrarily.

At operation 704, the locations of components are mapped. This comprises pre-selecting the positions of electrical equipment in at least the second compartment, such that the location of the compartment partition can be selected with knowledge that each component will fit within the meter main after the compartment partition is installed. While at least the first and second disconnects must be mapped, other equipment may be mapped as well, such as the load center or electrical cabling.

At operation 706, the compartment partition is installed in the second compartment such that first and second sub-compartments are defined therein. The compartment partition should be installed in-between the location of the first and second electrical disconnect switches as mapped in operation 704. Installing the compartment partition comprises locating the compartment partition within the second compartment and attaching it therein. The compartment partition may be attached at each of the holes defined by the tabs using a plurality of fasteners (see FIG. 6A).

At operation 708, the first electrical disconnect switch is installed in the first sub-compartment. Installing the disconnect generally comprises locating the disconnect within the first sub-compartment and attaching it therein using at least one fastener. The disconnects shown in the illustrated embodiments, like the compartment partition, include tabs for installation. The tabs generally comprise a plurality of holes through which fasteners may be inserted to attach the disconnect to the meter main. Disconnects are typically fastened to the rear wall of a housing of the meter main.

At operation 710, the second electrical disconnect switch is installed in the second sub-compartment. With respect to the process of installation, this is the same as the installation of the first disconnect at operation 708.

It should be understood that the order of the operations above is an aspect of merely one embodiment of the present invention, and select operations may be performed in various orders. For example, the disconnects may be installed prior to the compartment partition, so long as the installer is confident that the latter can be installed in-between the former.

While the systems and methods above have been described and disclosed in certain terms and have disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. Power distribution equipment, comprising:
a housing having at least four side walls and a rear wall, the side walls defining an equipment interior;
a primary barrier within the equipment interior and extending between opposite side walls of the housing, the primary barrier defining a first compartment and a second compartment within the equipment interior;
a first electrical disconnect and a second electrical disconnect, each of the electrical disconnects being located in the second compartment;
a compartment partition in the second compartment and extending thereacross, the compartment partition defining a first sub-compartment of the second compartment and a second sub-compartment of the second compartment; and
wherein the first electrical disconnect is in the first sub-compartment and the second electrical disconnect is in the second sub-compartment, and the first electrical disconnect and the second electrical disconnect are separated from each other by the compartment partition.

2. The power distribution equipment of claim 1, wherein the primary barrier extends vertically and wherein the compartment partition extends horizontally.

3. The power distribution equipment of claim 2, further comprising a load center located in one of the first sub-compartment or the second sub-compartment.

4. The power distribution equipment of claim 3, wherein the load center is inverted.

5. The power distribution equipment of claim 3, further comprising a plurality of electrical cables, wherein each of the first electrical disconnect and the second electrical disconnect are electrically connected to the load center by at least one electrical cable.

6. The power distribution equipment of claim 5, wherein the compartment partition defines a partition opening configured to allow at least one of the plurality of electrical cables to extend therethrough between the first and second sub-compartments.

7. The power distribution equipment of claim 6, wherein the partition opening fluidly connects the first sub-compartment and the second sub-compartment such that air can flow therebetween.

8. The power distribution equipment of claim 1, wherein the side walls of the housing define a depth thereof from a front edge of the side walls to the rear wall and wherein the compartment partition extends forward at least 80% of the housing depth from the rear wall toward a front surface of the power distribution equipment.

9. The power distribution equipment of claim 1, wherein the compartment partition extends forward at least 5 inches from the rear wall of the housing toward a front surface of the power distribution equipment.

10. The power distribution equipment of claim 1, wherein the side walls of the housing define a depth thereof from a front edge of the side walls to the rear wall, wherein horizontally opposing side walls of the housing define a housing width, and wherein vertically opposing side walls of the housing define a housing height.

11. The power distribution equipment of claim 10, wherein the housing width is no more than 28.25 inches, the housing height is no more than 43 inches, and the housing depth is no more than 7.87 inches.

12. The power distribution equipment of claim 1, wherein the side walls of the housing at the first sub-compartment include at least one knockout.

13. A compartment partition comprising a metal plate configured to divide a compartment interior of power distribution equipment into a first sub-compartment and a second sub-compartment, the compartment interior being defined by an upper compartment wall, a lower compartment wall, and two side compartment walls, the metal plate comprising a partition width and a partition depth and defining an opening therein.

14. The compartment partition of claim 13, wherein the compartment interior has a compartment depth greater than the partition depth, and wherein the partition depth is at least 80% of the compartment depth.

15. The compartment partition of claim 13, wherein the metal plate is configured to physically isolate a first electrical disconnect in the first sub-compartment from a second electrical disconnect in the second sub-compartment.

16. The compartment partition of claim 15, wherein the compartment interior has a plurality of electrical cables located therein, and wherein the opening is configured to allow at least one of the plurality of cables to extend therethrough from one of the first and second sub-compartments to another one of the first and second sub-compartments.

17. The compartment partition of claim 13, wherein the opening fluidly connects the first sub-compartment and the second sub-compartment such that air can flow therebetween.

18. A method of separating a first electrical disconnect switch and a second electrical disconnect switch in power distribution equipment, the power distribution equipment comprising a housing having at least four side walls and a rear wall, the side walls defining an equipment interior, the housing further having a barrier extending between opposite side walls of the housing and defining a first compartment and a second compartment within the equipment interior, the method comprising:
installing a compartment partition within the second compartment such that the second compartment defines a first sub-compartment and a second sub-compartment;
installing the first switch in the first sub-compartment;
installing the second switch in the second sub-compartment;
wherein the second compartment has a compartment depth;
wherein the compartment partition has a partition depth; and
wherein the side walls of the housing define a housing depth from a front edge of the side walls to the rear wall and the partition depth is at least 80% of the housing depth.

19. The method of claim 18, further comprising installing a load center in the first sub-compartment, wherein the load center is installed in an inverted configuration.

20. The method of claim 19, further comprising installing a plurality of electrical cables, wherein the compartment partition defines a partition opening, and wherein installing the plurality of electrical cables includes routing at least one of the plurality of electrical cables through the partition opening between the first and second sub-compartments.
